(19) United States
(12) Patent Application Publication
(10) Pub. No.: US 2026/0312822 A1
(43) Pub. Date: Oct. 8, 2026

(54) MANAGING ACCESS TO RESOURCES FOR ENHANCED RESOURCE SECURITY

(71) Applicant: Palo Alto Networks, Inc., Santa Clara, CA (US)

(72) Inventors: Ohad Bobrov, Tel Aviv (IL); Yan Aksenfeld, Rehovot (IL)

(21) Appl. No.: 19/484,667

(22) PCT Filed: May 13, 2024
(86) PCT No.: PCT/IL2024/050461

§ 371 Date: Nov. 14, 2025

Related U.S. Application Data
(60) Provisional application No. 63/466,287, filed on May 14, 2023.

(51) Int. Cl. H04L 9/32; H04L 9/08

(52) U.S. Cl. CPC H04L 9/3242; H04L 9/0863

(57) ABSTRACT

Access to shielded resources via a web browser is constrained. Based on detecting an attempt by a user to access a resource with a first password via an instance of a web browser, the web browser retrieves an encryption key associated with the requested resource. The web browser generates a message authentication code (MAC) based on the first password and the retrieved encryption key associated with the first resource (e.g., by encrypting the first password with the encryption key). The web browser submits the access request with the MAC for authentication of the MAC. If the MAC is authenticated, access to the resource via the web browser is granted.

### RELATED APPLICATIONS

The present application claims the benefit under 35 U.S.C. 119(e) of U.S. Provisional Application 63/466,287 filed on May 14, 2023, the disclosure of which is incorporated herein in its entirety by reference.

### FIELD

Embodiments of the disclosure relate to providing cybersecure access channels and workspaces for communications networks and digital resources

### BACKGROUND

The various computer and communications technologies that provide modern communications networks and the internet, encompass a large variety of virtual and bare metal network elements (NEs) that support operation of the communications networks and the stationary and/or mobile user equipment (UE) that provide access to the networks. The technologies have enabled the information technology (IT) and the operations technology (OT) that are the bedrocks of today's society and provide a plethora of methods, devices, infrastructures, and protocols for controlling industrial equipment, supporting business operations, and generating and propagating data, voice, and video content via the internet. Information of all types is readily available through the internet to most of the global population, independent of physical location. And today large segments of the global community regularly work remotely from their homes, coffee shops, and vacation venues via connectivity to their employers and work groups using their personal, Bring Your Own Device (BYOD), UEs—such as their personal smartphones, laptops, tablets, and home desktops. The networks have democratized the consumption of information and accelerated changes in societal infrastructure.

However, the benefits provided by the computer and communications technologies are not without their costs. The same technologies and benefits have substantially increased the difficulty in providing and maintaining legitimate personal and collective rights to confidentiality, and in protecting the integrity and safety of the selfsame industrial and business operations that the technologies have enabled against violation and damage from cyberattacks.

For example, a fingerprint of cyberattack surfaces characterizes each UE, whether it is a personal, spatially untethered BYOD or an enterprise, workplace user equipment (WPUE) and provides vulnerabilities for exploitation by malicious hackers to wreak havoc possibly on the UE and more often on entities and systems to which the UE connects. Each UE, and in particular a BYOD, in addition to functioning as a person's communications node, is a potential cyberattack node for any communications network to which the UE connects. For enterprises that must be in contact with clients, workers, and/or associates that have segued at least in part to remote work using their personal BYODs, vulnerability to cyberattack is amplified by a number of their remote contacts, the software configurations in the contacts' respective BYODs, and the manifold of non-enterprise communications that the contacts engage in using the UEs. The gravitation of enterprise data and storage resources to the cloud and the proliferation of technologies such as Infrastructure as a Service (IaaS), Platform as a Service (PaaS), and Software as a Service (Saas) that remote contacts access and use further compounds the complexity of providing for appropriate cyber protection.

### SUMMARY

An aspect of an embodiment of the disclosure relates to providing a cyber secure communications system, hereinafter also referred to as “CyberSafe”, that provides enhanced visibility to communications traffic propagated by the system and operates to provide cyber protection for and secure access to a digital resource of a body of resources for an authorized user of a UE—a BOYD or a WPUE—associated with the body of resources.

For convenience of presentation it is assumed that the body of digital resources is owned by an enterprise, optionally referred to as “MyCompany”, that employs or engages in tasks with users authorized to use a UE associated with the body of resources to access a MyCompany resource. A UE associated with the body of resources is a UE that has been configured in accordance with an embodiment of the disclosure to enable an authorized user access a MyCompany resource. A UE associated with the body of resources may be referred to as a MyCompany UE and a user authorized to use a MyCompany UE to access a MyCompany resource may be referred to as a MyCompany user or simply a user.

Digital resources include any information in digital format, at rest or in motion, and comprise by way of example electronic documents, images, files, data, databases, and/or software, which refers to executable code and/or data. Digital resources also include any software and/or hardware that may be used to operate on or generate a digital resource. A digital resource in motion is a digital resource that is being used, and/or operated on, and/or in transit between nodes of a communication system. A digital resource at rest is a digital resource that is in storage and not in motion.

In an embodiment CyberSafe comprises an, optionally cloud based, data and processing security hub, also referred to as a CyberSafe Hub, and a web browser, also referred to as a CyberSafe secure web browser (SWB), resident in a CyberSafe isolated secure environment (CISE) of a MyCompany UE configured by, or in accordance with, CyberSafe. In an embodiment, the CISE operates to isolate software (code and/or data) comprised in the SWB and in other applications that may reside in CISE from software in the UE, also referred to as UE ambient software, that may be used for tasks not associated with MyCompany resources, and from software external to the UE. In an embodiment ingress and egress of data respectively into and out from CISE and between applications in CISE is monitored and controlled by the SWB, which is configured by CyberSafe to enforce CyberSafe and/or MyCompany security policies relevant to and access to data within CISE movement of data into and out from CISE. The isolation and control of movement of and access to data, and enforcement of policies operate to provide enhanced protection against cyber damage and security against leakage of data from and/or into MyCompany resources that may result from communication with and via a MyCompany UE.

In an embodiment monitoring ingress and egress of data comprises monitoring communications supported by SWB, storing and processing data comprised in the monitored communications, and making the data available to the CyberSafe Hub and to MyCompany IT. In an embodiment, monitoring is performed on communications outgoing from CISE and from SWB before the outgoing communications are encrypted by SWB and on communications incoming into CISE after the incoming communications are decrypted by SWB. In addition, user interactions with the SWB may be monitored locally or by CyberSafe security hub. As a result, communications between the UE and MyCompany and actions of a MyCompany user interfacing with the UE are substantially completely visible to CyberSafe and to MyCompany and may be processed by the SWB, the hub and/or other trusted components associated with MyCompany.

In accordance with an embodiment of the disclosure, the SWB is configured to request from the CyberSafe security hub upon launch from the MyCompany UE by a MyCompany user, permission to run from the UE and comprises software, optionally referred to as cladding, such as anti-injection and/or anti-exploitation software, that operates to protect the SWB from cyber damage. Upon receiving a request for permission, the CyberSafe Hub optionally checks the ID of the UE user and vets integrity of the web browser software and the security posture of the UE. If the user ID is acceptable, the software integrity, and/or cladding, are found to be intact, and/or the security posture of the UE environment satisfactory, the security hub may permit operation of the SWB from the UE and optionally issues the SWB a security token for presentation to access a MyCompany resource.

In an embodiment the CyberSafe security hub, the CyberSafe SWB, and an Identity Provider (IDP) that operates to control access to MyCompany's digital resources are configured to cooperate in permitting an authorized user of a MyCompany UE access to a resource of MyCompany's digital resources.

An aspect of an embodiment of the disclosure relates to providing a method by which CyberSafe may operate to constrain MyCompany users to use a CyberSafe SWB to access a selection of MyCompany resources.

In an embodiment to constrain the user to use only a MyCompany SWB to access the selection of resources, CyberSafe requires the user to onboard an SWB that the user uses to access the selected resources to an enhanced cyber protection procedure which operates to shield the selected resources from access by non-MyCompany browsers. The enhanced cyber protection procedure may be referred to as a “CyberSafe Shield” or simply “Shield”, and the selected resources, “selected and shielded resources” (S&SRs).

To onboard Shield the user may be instructed to access, optionally CyberSafe Hub, via the user SWB to reset a user password (PW) associated with the user and the SWB. In response, CyberSafe Hub associates an encryption key, referred to as a Shield Key, with the reset password, optionally referred to as a Shield password (PW). The CyberSafe Hub uses the Shield Key and optionally the Shield PW to generate a secure access token, optionally referred to as a Shield Message Authentication Code (S-MAC), for presentation to an S&SR for access to the S&SR. Optionally, using the Shield password and Shield Key to generate an S-MAC comprises encrypting the Shield PW using the Shield Key. Optionally, using the Shield PW and Shield Key comprises hashing the PW and encrypting the hashed PW using the Shield Key to generate the S-MAC. Optionally, the S-MAC comprises the Shield PW concatenated with the encrypted Shield PW. For convenience of presentation any procedure for generating an S-MAC using the Shield Key in accordance with an embodiment of the disclosure may be referred to as a PW-Shielding procedure. CyberSafe distributes the S-MAC to an access control system that gatekeeps access to the S&SRs and configures the access control system and S&SRs so that a web browser is permitted access to an S&SR only if the browser presents an S-MAC and optionally an associated Shield PW for authentication.

CyberSafe configures the MyCompany SWB to access and use the Shield Key to process the Shield PW to generate and present for authentication the S-MAC whenever the user attempts to access an S&SR using the SWB. In an embodiment the Shield Key is stored in a secure memory, an SWB vault, of the SWB so while available for use by the SWB to generate an S-MAC, the Shield Key is unavailable to the user. In an embodiment the Shield Key may be stored in a CyberSafe Hub secure vault and the SWB allowed access to the Shield Key via the CyberSafe Hub. The user does not have access to or knowledge of the Shield Key, nor the S-MAC generated using the Shield Key, and the process of generating an S-MAC using the Shield Key is opaque to the user. The user therefore is not able to use a non-MyCompany web browser to access an S&SR.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1 schematically shows a MyCompany UE configured having a CyberSafe CISE and SWB to provide cyber security to an enterprise referred to as MyCompany, in accordance with an embodiment of the disclosure;

FIGS. 2A-2C show a flow diagram of a sign-in procedure by which the SWB shown in FIG. 1 may engage in a handshake with a CyberSafe Hub to acquire a token for use in accessing a MyCompany resource, in accordance with an embodiment of the disclosure;

FIG. 3 shows a flow diagram of an onboarding procedure by which a MyCompany user may onboard a CyberSafe Shield, in accordance with an embodiment of the disclosure; and

FIGS. 4A and 4B show a flow diagram illustrating a scenario of a user operating a browser to access a MyCompany shielded resource, in accordance with an embodiment of the disclosure.

### DETAILED DESCRIPTION

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. The phrase “in an embodiment”, whether or not associated with a permissive, such as “may”, “optionally”, or “by way of example”, is used to introduce for consideration an example, but not necessarily a required configuration of possible embodiments of the disclosure. Unless otherwise indicated, the word “or” in the description and claims is considered to be the inclusive “or” rather than the exclusive or, and indicates at least one of, or any combination of more than one of items it conjoins. Whereas features and actions of flow diagrams shown in the figures and discussed in the specification are presented and discussed substantially in an ordered sequence of flow diagram blocks the features and actions in a given flow diagram may be undertaken in an order other than that presented in the flow diagram.

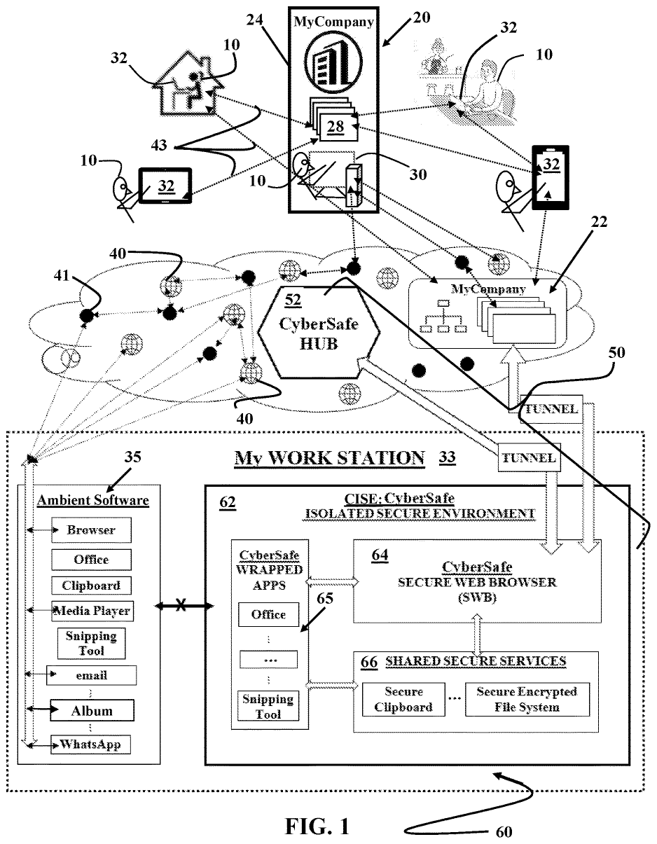

FIG. 1 schematically shows a CyberSafe system 50 that operates to provide cyber secure communication for a communications network of an enterprise 20, also referred to as MyCompany 20 or simply MyCompany, and for MyCompany users 10 that use the communications network, in accordance with an embodiment of the disclosure. MyCompany may have cloud based digital resources 22, premises 24 housing on-premise servers (not shown) for storing and processing MyCompany on-premise digital resources 28, and WPUEs 30 for use by MyCompany users 10 when on-premise for accessing, using, and processing the cloud based and on-premise resources to conduct MyCompany business. MyCompany may permit users 10 when off-premise to access MyCompany resources from various locations using any of various types of BYODs 32. It is assumed that MyCompany users 10 may use their respective BYODs 32 for personal activities, and that MyCompany users when on-premise may, in accordance with permissions defined by MyCompany policy, be allowed to use WPUEs 30 for personal activities. Personal activities may include web browsing, social networking, uploading, and downloading material, via the cloud infrastructure of communication nodes 41 and websites 40. The MyCompany network, may be required to support, as schematically indicated by double arrow-head dashed lines 43, communication between any of various combinations of MyCompany on-premise digital resources 28, cloud based digital resources 22, on-premise users 10 using WPUEs 30 installed in a MyCompany premisses 24, and off-premise users 10 using BYODs 32 at various off-premise locations.

In accordance with an embodiment of the disclosure CyberSafe 50 comprises an optionally cloud based CyberSafe processing and data hub 52 and a software architecture 60 that operates to cyber protect MyCompany communications and digital resources in each of a plurality of MyCompany UEs, BYODs 32 and/or WPUEs 30, used by MyCompany users 10 to access and use MyCompany resources. CyberSafe Hub 52 comprises and/or has access to cloud based and/or bare metal processing and memory resources required to enable and support functionalities that the hub provides to CyberSafe 50 and components of CyberSafe.

By way of example, FIG. 1 schematically shows a CyberSafe software architecture 60 that configures a MyCompany UE 33, to protect MyCompany digital resources, at rest and/or in motion, and provide cyber secure access to the resources for a user 10 that may use MyCompany UE 33. MyCompany UE 33 may be a BYOD or a WPUE and be referred to as My-WorkStation 33.

Architecture 60 comprises a CyberSafe isolated environment, CISE 62, that is isolated from ambient software 35 resident in My-WorkStation 33 and comprises an SWB 64, resident in CISE 62. Ambient software 35 may typically include data and applications that are not intended for use in conducting MyCompany business. By way of example, ambient software 35 may comprise a browser, an office suite of applications, a clipboard, an album of family images, a photo album and WhatsApp. CISE 62 may also include a set 65 of applications optionally imported from ambient software 35 and wrapped and optionally containerized by CyberSafe to associate cybersecurity features required by CyberSafe and/or MyCompany policy features with the applications. In an embodiment CISE comprises an ensemble of shared secure services 66 that may be accessed for use by SWB 64 and by applications in set 65 vian SWB 64. Shared secured service 66 optionally comprise a secure clipboard and a secure encrypted File System.

CISE 62 provides an isolated security domain delimited by a substantially continuous security perimeter generated and supported by security applications, features, and functionalities of SWB 64, shared secure services 66, and wrapping of wrapped applications 65. In accordance with an embodiment, CISE 62 may be configured to provide cyber security and isolation using methods of, and compliant with, such standards as PCI DSS (Payment Card Industry Data Security Standard), HIPAA (Health Insurance Portability and Accountability Act), and/or SOC2 (American Institute of CPAs' Service Organization Control). Optionally CISE 62 is isolated from the ambient software on the network level.

In an embodiment to provide isolation and security SWB 64 is configured to monitor and control ingress and egress of data respectively into and out from CISE 62 and between applications in CyberSafe wrapped applications, shared secure services 66 and/or SWB 64. SWB 64 is advantageosuly configured by CyberSafe to enforce CyberSafe and/or MyCompany security policies relevant to and access to and movement of data within and into and out from CISE. The isolation and control of movement of and access to data, and enforcement of policies operate to provide enhanced protection against cyber damage and security against leakage of data from and/or into MyCompany resources that may result from communication using a MyCompany UE.

In an embodiment monitoring ingress and egress of data comprises monitoring communications supported by SWB 64, storing and processing data comprised in the monitored communications and making the data available to the CyberSafe Hub and to MyCompany IT. In an embodiment, monitoring is performed on communications outgoing from CyberSafe isolated environment CISE 62 (FIG. 1) before the outgoing communications are encrypted by SWB 64 and on communications incoming into CISE after the incoming communications are decrypted by SWB 64. As a result user browsing is substantially completely visible to CyberSafe and to MyCompany and can be processed locally or remotely. Monitoring may be substantially continuous, stochastic, or periodic. Stochastic monitoring comprises monitoring communications for monitoring periods of limited duration that begin at onset times that are randomly determined, optionally in accordance with a predetermined probability function or responsive to occurrence of a particular type of event. Periodic monitoring comprises continuous monitoring of communications during monitoring periods at periodic onset times. Monitored communications may be mirrored by SWB 64 to a destination in CyberSafe Hub and/or MyCompany for storage and/or processing or may be filtered for data of interest before being transmitted to a destination in CyberSafe Hub and/or MyCompany for storage and/or processing. Features and constraints that configure how monitored communications are handled by SWB 64 may be determined based on CyberSafe and/or MyCompany policy. Such policy may specify how processing of data is shared between the local SWB and the CyberSafe Hub.

In an embodiment, SWB 64 may be an independent application comprising CyberSafe features and/or functionalities, or an existing web browser, such as Google Chrome, Microsoft Edge, Apple Safari, Mozilla Firefox, Opera, or Brave, modified and provided with additional CyberSafe features and/or functionalities by changes and/or additions to browser code and/or by integrating with CyberSafe extensions. The features and functionalities may be incorporated into the existing browser and the browser converted to a CyberSafe SWB by: interfacing with the input and output of the existing browser using operating system hooks; patching the original binary of the browser; building a dedicated extension on top of the browser's API and/or SDK; and/or dynamically modifying memory of the browser when the browser is in operation.

By way of example, the features and/or functionalities, hereinafter generically referred to as functionalities, may comprise, at least one or any combination of more than one of functionalities that enable SWB 60 to: cooperate with a MyCompany IDP to verify and authorize a user 10 to access CISE 62 and MyCompany resources; acquire data characterizing websites visited by MyCompany users that may be used to classify cyber risks associated with the websites; acquire data characterizing browser extensions that may compromise SWB 64 security features; acquire data that may be processed to determine normal behavior and use of MyCompany resources by MyCompany users as a group and/or as individuals; monitor engagement of a MyCompany user with a MyCompany resource and control the engagement to enforce CyberSafe and/or MyCompany security constraints.

In an embodiment enforcing CyberSafe and/or MyCompany security constraints comprises requiring that all communications between UE 33 and a MyCompany resource be propagated via an SWB 64 and CyberSafe tunnels that connect the SWB to the resource and enforcing CyberSafe and/or MyCompany permissions to the resources. Optionally, enforcing security constraints comprises identifying anomalies in communications between UE 33 and a company resource and operating to eliminate or ameliorate damage from an identified anomaly and generate an alert to its occurrence.

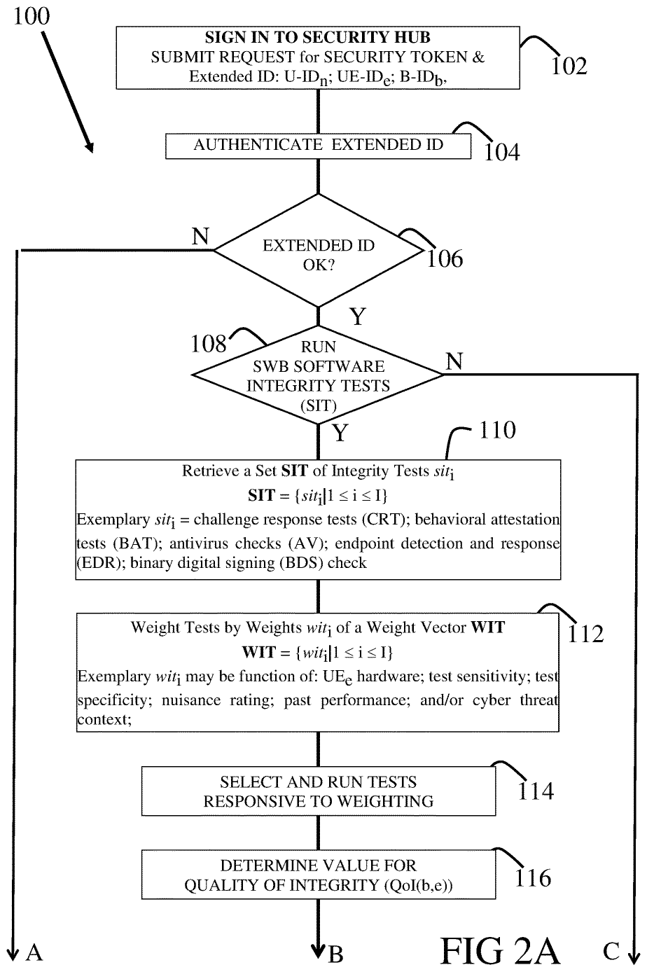

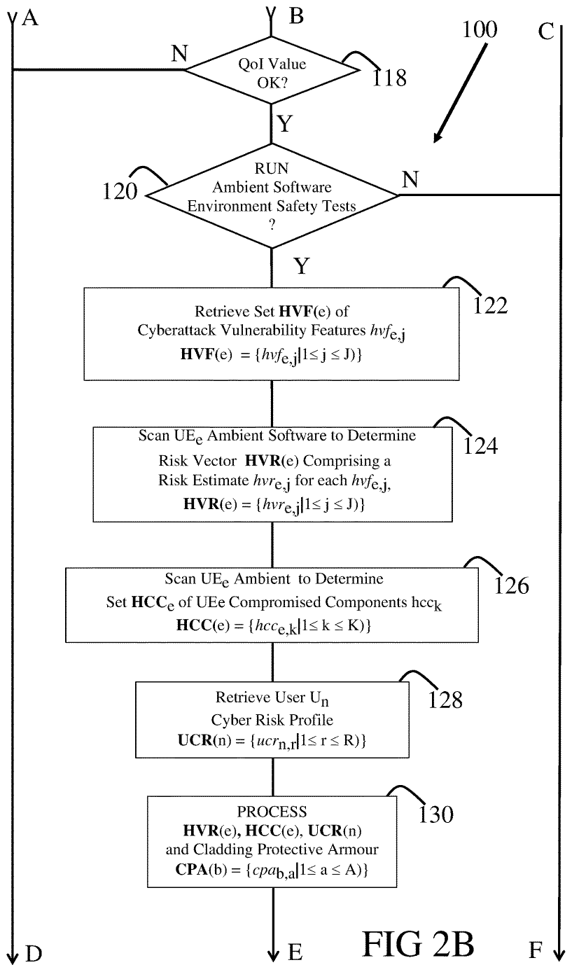

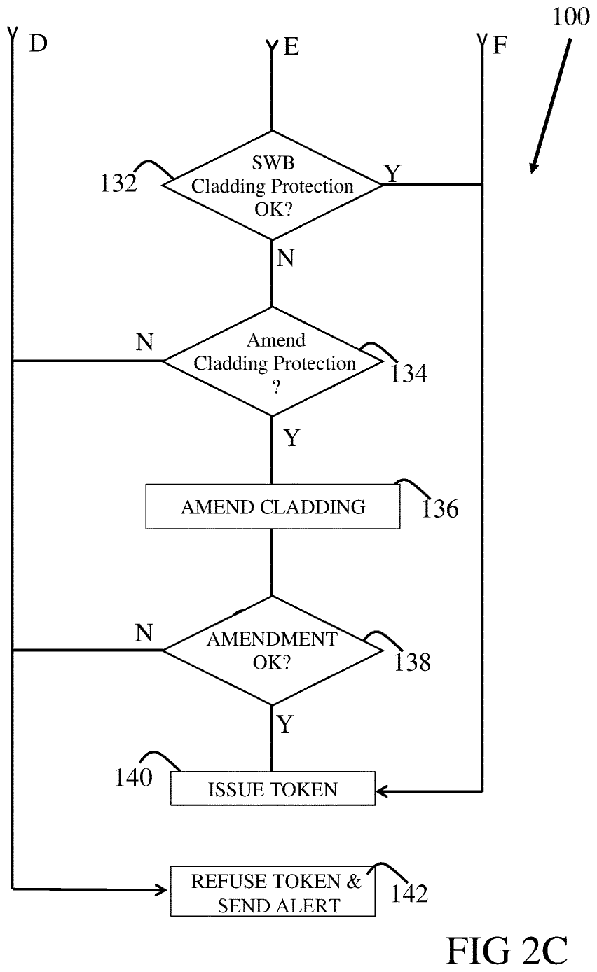

Flow diagrams presented in FIGS. 2A-4B show elements of procedures performed by a CyberSafe System and an SWB, such as CyberSafe system 50 and SWB 64, that exhibit and illustrate functionalities of the CyberSafe system and of the SWB, in accordance with an embodiment. The discussion assumes that the CyberSafe system provides cyber security services to a given MyCompany enterprise having a plurality of users Uₙ (1≤n≤N) identified by respective user IDs, U-IDₙ (1≤n≤N). The users are assumed to have access to and use user equipment identified by user equipment IDs, UE-IDₑ (1≤e≤E) and that CyberSafe has configured the UEs with CISEs and CyberSafe browsers, SWBs, referenced by an index b respectively identified by SWB browser IDs, B-ID_{b}.

FIGS. 2A-2C show a flow diagram 100 of a sign-in procedure by which a given user Un using user equipment UEₑ contacts the CyberSafe security hub to request authorization to access and use CISE in UEₑ and have a resident SWB_{b} in CISE issued a security token for access to MyCompany resources.

In a block 102 user Uₙ operates UEₑ to sign in to the CyberSafe security hub and submit a request for the security token, the request comprising an Extended ID that includes the user ID, U-IDₙ; the user equipment ID, UE-IDₑ; and an SWB_{b} ID, B-ID_{b} that identifies the SWB installed in UEₑ. U-IDₙ may include the username, a password, and/or such data that associates the user with UEₑ, SWB_{b}, and/or MyCompany, such as a date at which the user was first registered as a MyCompany user. UE-IDₑ may include any suitable identifier such as a MAC (media access) address, a UUID (Universal Unique Identifier), or an IMSI (international mobile subscriber identity), and/or information that associates UEₑ with user Uₙ, SWB_{b}, and/or MyCompany. The B-ID_{b} may include a browser user agent string, any suitable identifier that CyberSafe assigns SWB_{b}, and/or information that associates SWB_{b} with UEₑ, Uₙ, and/or MyCompany.

It is noted that a given user Uₙ may be associated with more than one UEₑ and/or more than one SWB_{b}, and the user ID U-IDₙ may comprise data that identifies the associations. Similarly, a given user UEₑ may be associated with more than one Uₙ and/or more than one SWB_{b}, and a given SWB with more than one Uₙ and/or more than one UEₑ, and the respective IDs, UE-IDₑ and B-ID_{b} may comprise data that maps the associations. Any combination of one or more of Uₙ, UEₑ, and/or SWB_{b} may comprise a Time of Day (ToD) for each of at least one previous sign in to CyberSafe.

Optionally, in a block 104 the CyberSafe Security Hub authenticates the Extended ID. Authenticating the Extended ID may comprise engaging in a three factor authentication of user Uₙ and determining consistency of the associations and/or ToDs in at least one of U-IDₙ, UE-IDₑ, or B-ID_{b} and another at least one of the IDs.

In a decision block 106 if the Extended ID is not OK, the hub proceeds to a block 142, denies the requested token, and optionally sends an alert of the refusal to the CyberSafe Hub. On the other hand if the Extended ID is OK the hub optionally proceeds to a decision block 108 to decide whether or not to run an integrity test on the SWB_{b} software. The decision to run or not to run an integrity test may depend on a MyCompany and/or CyberSafe testing policy. The policy may depend on when the CyberSafe Hub ran a last integrity test on the SWB_{b}, and/or UEₑ, a user profile characterizing user Uₙ browsing behavior and internet use pattern, and/or a feature of a cyberattack landscape. For example, MyCompany may have a policy that a delay between integrity tests be no less than or greater than certain lower and upper bound delays. A decision may depend on whether user Uₙ browses to cyber dangerous websites listed in a list of dangerous websites at a frequency greater than a predetermined frequency or whether the user tends to be lax in updating passwords or patching applications. A cyberattack landscape may comprise frequency and/or severity of cyberattacks that have recently been experienced by MyCompany or other enterprises and/or what types of cyberattacks have been encountered. Optionally, if the decision in decision block 108 is to skip an integrity test, the hub proceeds to a block 140 and issues the desired token. If the decision is to undertake an integrity test, the hub may proceed to a block 110 and retrieve from a database the hub comprises or to which the hub has access, a set, “SIT”, of at least one software integrity test, “sitᵢ”, where SIT={sitᵢ|1≤i≤I} that may be used to determine integrity of the SWB_{b} software. An exemplary SIT may comprise at least one, or any combination of more than one of:
sit₁=CRT (challenge response test);
sit₂=BAT (behavioral attestation test);
sit₃=AV (antivirus check);
sit₄=EDR (endpoint detection and response);
sit₅=BDS (binary digital signing); [symbol]
sit_{I}

In a block 112 the CyberSafe Hub determines a weight vector WIT comprising a weight witᵢ for each sitᵢ that provides an estimate for how appropriate the test sitᵢ is for determining integrity of the SWB_{b} software. In an embodiment a witᵢ for a given sitᵢ is a function of:
UEₑ hardware type, for example if the UEₑ is a mobile device, a tablet, or desktop which may limit what types of the given sitᵢ, may be performed on the UEₑ;
sensitivity, the true positive rate of the given sitᵢ;
specificity, the true negative rate of the given sitᵢ;
nuisance rating, which provides a measure of inconvenience performance of the test causes user UEₑ;
past performance of the test; and/or
a current cyberattack context, which, identifies current prevalence and severity of cyberattack types.

In a block 114 CyberSafe Hub runs a selection of tests sitᵢ on SWB_{b} software responsive to their respective weights witᵢ, for example where a greater weight witᵢ indicates greater relevance, by selecting integrity tests sitᵢ for which their respective weights are greater than a median weight witᵢ.

In a block 116 CyberSafe Hub determines a value for a measure of a QoI(e,b) (quality of integrity) for SWB_{b} software in UEₑ responsive to a measure of integrity returned by each of the selected tests sitᵢ. In an embodiment QoI(e,b) is an average of the measures of integrity provided by the sitᵢ weighted by their respective weights witᵢ. Optionally in a decision block 118 CyberSafe Hub determines if the QoI value is satisfactory or not. If the QoI is not satisfactory the hub proceeds to block 142 and denies issuing the token and optionally sends an alert. On the other hand if the QoI is satisfactory the hub proceeds to a decision block 120 to determine whether or not to run ambient software environment tests on UEₑ

Software environment tests are tests to determine to what extent, if at all, ambient software in UEₑ has been compromised by cyber damage or is insufficiently protected against cyber damage. The decision whether or not to perform the environment test on UEₑ may be based on many of the same considerations that are weighed when making the decision as to whether or not perform to integrity tests. For example, the decision may depend on MyCompany and/or CyberSafe policy and such factors as UEₑ hardware, for example whether the UEₑ is a mobile phone or laptop, when a last environment test was run on UEₑ, a browsing behavior pattern of user Uₙ, and/or a feature of a cyberattack landscape.

Optionally, if the decision in decision block 120 is to skip the software environment test, the CyberSafe Hub may proceed to block 140 and issue the desired token. If on the other hand the decision is to undertake an environment test, the hub may optionally proceed to a block 110 and retrieve from a database a set “HVF(e)” of at least one cyberattack vulnerability feature hvf_{e,j} to be determined as present or absent, where HVF(e)={hvf_{e,j}|1≤j≤J}. HVF(e) may comprise static and/or dynamic vulnerability features. Static vulnerability features are features that are code and/or data elements comprised in the ambient software of UEₑ that are considered to render the ambient software and/or digital resources that are not comprised in the ambient software, such as CyberSafe and/or MyCompany resources, vulnerable to cyberattack. Dynamic vulnerability features are temporary vulnerability features, such as whether the UEₑ is connected to a public WiFi or to a cyber dangerous website, that characterize a current use of UEₑ. An exemplary HVF(e) may comprise at least one, or any combination of more than one of vulnerability features whose presence or absence may be determined by response to, optionally, the following queries:
hvfe, 1=AV (anti-virus)/EDR (Endpoint Detection & Response) installed?;
hvf_{e,2}=firewall installed and enabled?;
hvf_{e,3}=OS (operating system) patched to the latest version?;
hvf_{e,4}=applications patched to latest versions?;
hvf_{e,5}=access to UEₑ require authentication?;
hvf_{e,6}=dangerous software defaults present?;
hvf_{e,7}=is public Wi-Fi being used?;
hvf_{e,8}=UEₑ connected to a VPN (virtual private network)?;
hvf_{e,9}=security level of connected network?; [symbol]
hvf_{e,J}.

Optionally, in a block 124 CyberSafe Hub scans the UEₑ ambient software environment to detect presence of each hvf_{e,j} and determine a risk vector HVR(e) comprising a cyberattack risk estimate hvr_{e,j} for each hvf_{e,j,}, where HVR(e)={hvr_{e,j}|1≤j≤J)}. Determining a risk estimate for a given vulnerability hvf_{e,j} is generally dependent on the type of vulnerability and a cyberattack landscape. For example, determining a risk estimate for a given public Wi-Fi may be dependent on a physical location of the Wi-Fi, current traffic carried by the Wi-Fi at a time for which the estimate is made, and recent history of cyberattacks attempted via the Wi-Fi. Risks associated with patching may be a function of types of types of patching required or installed.

In a block 126 CyberSafe may scan UEₑ ambient software to determine a set HCC(e) of compromised components hccₖ in the ambient software, where HCC(e)={hcc_{e,k}|1≤k≤K)}. And in a block 128 CyberSafe may retrieve from a CyberSafe database a user profile that characterizes a cyber risk profile of the user optionally comprising a set UCR(n) of risk components ucr_{n,r} (1≤r≤R), where UCR(n)={ucr_{n,r}|1≤r≤R)}, that may be used to characterize behavioral features of user Uₙ that expose CyberSafe and/or MyCompany to cyberattack.

In a block 130 CyberSafe processes HVR(e), HCC(e), UCR(n), and/or a set CPA(b) of cyber cladding software attributes of SWB_{b} that respectively indicate measures of cyber security that the attributes provide to SWB_{b} to determine if CPA(b) provides SWB_{b} with advantageous protection against cyberattacks. For example, for a user with high privilege access to MyCompany resources may be required by CPA(b) to run additional security checks and install additional security controls, such as EDR, in order to allow user access a MyCompany resource. Additionally, some capabilities that have impact on the system's vulnerability to cyberattacks may be constrained or disabled by CPA(b) if the user is accessing an unknown website or a websites with low security reputation (and therefore high risk). In an embodiment processing is performed by a neural network configured to operate on an input feature vector comprising component features based on components of HVR(e), HCC(e), UCR(n), and/or CPA(b).

Optionally, in a block 132 if the CyberSafe Hub determines that the cladding protection is advantageous, the hub proceeds to block 140 and issues the requested token. If on the other hand the cladding protection is not advantageous, the hub may proceed to a block 134 to determine whether or not to amend the cladding protection to improve protection. If the hub decides not to amend, the hub may proceed to block 142 and deny the token and raise an alert. On the other hand if the decision is to amend the cladding, the hub proceeds to a block 136, amends the cladding and optionally proceeds to a decision block 138 to determine if the amendment has resulted in sufficient improvement in cyber protection or not. If the improvement is not sufficient CyberSafe Hub proceeds to block 142 and denies the token.

In an embodiment to operate to ensure that a MyCompany user uses only a MyCompany SWB to access a selection of MyCompany digital resources, (S&SRs), CyberSafe may require each MyCompany user to access an S&SR only from a MyCompany SWB having onboarded to CyberSafe Shield, optionally from the CyberSafe Hub. CyberSafe Shield provides the SWB with a Shield Key, associated with a user Shield PW. Shield configures the SWB to use the Shield Key to encrypt, optionally the SWB Shield PW, to generate an S-MAC comprising the encrypted Shield PW, and optionally the Shield PW, for presentation to an S&SR whenever requesting access to the S&SR. CyberSafe operates to provide an access control system that gatekeeps access to S&SRs with the S-MACs of SWBs that have onboarded to Shield and configures the access control system and S&SRs to allow access to the S&SRs only to SWBs that present the S&SRs with an S-MAC. The Shield Key provided to an SWB by Shield is stored in a safe memory of the SWB and is unknown to and inaccessible by the user, and generation of an S-MAC using the Shield Key is opaque to the user so that the user never has access to an S-MAC generated using the Shield Key. As a result, MyCompany users are unable to port a Shield Key or an S-MAC to a browser that is not a MyCompany SWB and are constrained to use only MyCompany SWBs to access the MyCompany S&SRs.

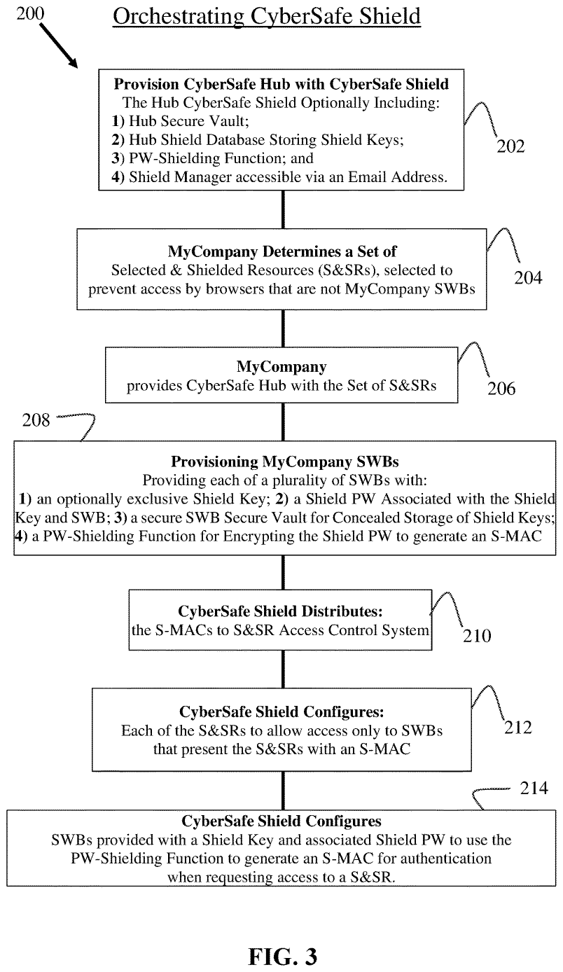

FIG. 3 shows a schematic flow diagram 200 of a procedure, also referred to by the label 200, by which CyberSafe and MyCompany may be configured to orchestrate and establish cooperation to use CyberSafe in accordance with an embodiment of the disclosure. Actions and/or tasks disclosed in flow diagram 200 that are recited as being undertaken by a particular entity such as CyberSafe, MyCompany, Shield and/or components of thereof, are not limited to being undertaken by the recited entity and may be undertaken by a suitable entity other than the recited entity. For example, a particular task undertaken by Shield may be undertaken by MyCompany, optionally in cooperation with CyberSafe.

In a block 202 of procedure 200 a CyberSafe Hub of a CyberSafe system such as CyberSafe Hub 22 of CyberSafe System 50 (FIG. 1) that operates to provide security functionalities to MyCompany 20, for example functionalities illustrated by flow diagram 100 (FIGS. 2A-2C), is provisioned with Shield, in accordance with an embodiment. Provisioning the CyberSafe Hub with Shield comprises providing the hub with an inventory of Shield Keys, a PW shielding function for generating S-MACs, a hub secure vault in which Shield Keys are securely stored, and a hub Shield Database that records deployment of Shield Keys. The hub database may comprise data records that identify Shield Keys that are assigned to given MyCompany SWBs and associate the assigned Shield Keys with user passwords and S-MACs that are presented by the given SWBs to access MyCompany resources. The CyberSafe Hub may also be provided with a Shield Manager that performs management tasks for Shield, such as by way of example managing interfacing with MyCompany SWBs to assign Shield Keys to the SWBs, updating the hub Shield Key Database, and distributing S-MACs associated with MyCompany SWBs to a MyCompany access control system and/or S&SRs. The Shield Manager may be provided with an email address to facilitate communications between the Shield Manager and MyCompany users.

Optionally in a block 204 MyCompany determines a set of S&SRs that are to be protected by Shield to prevent the S&SRs from being accessed by browsers that are not MyCompany SWBs and in a block 206 MyCompany provides the CyberSafe hub with a list of the S&SRs in the set.

In a block 208 Shield optionally provisions MyCompany SWBs for cooperating with CyberSafe Shield and provides each of a plurality of the SWBs with the Shield Manager e-mail address, a Shield Key optionally exclusive to the SWB, a Shield PW, optionally provided in a password reset procedure described below, associated with the Shield Key and SWB, and an SWB secure vault for concealed storage of the Shield Key. Shield provides the SWB with the PW-Shielding function for accessing and encrypting the Shield PW using the Shield Key to generate an S-MAC, and software supporting presentation of the S-MAC to an S&SR for authentication when requesting access to the S&SR. In an embodiment the S-MAC comprises an encryption generated using the Shield Key. Optionally, the encryption comprises an encryption of the Shield PW as optionally reset by user and/or a function of the Shield PW. The function of the Shield PW may include a hash of the Shield PW. Optionally the S-MAC comprises a concatenation of the Shield PW and the encryption.

In a block 210, CyberSafe shield distributes S-MACS generated by SWBs using Shield Keys to an access control system or systems that gatekeep/s access to S&SRs, and in a block 212 configures the access control system/s and the S&SRs to allow access to the S&SRs only to SWBs that present an S-MAC to satisfy “Shield Authentication”.

In a block 214 Shield configures SWBs provided with a Shield Key and a Shield PW to use the PW-Shielding Function and generate an S-MAC for presentation to an S&SR whenever requesting access to the S&SR.

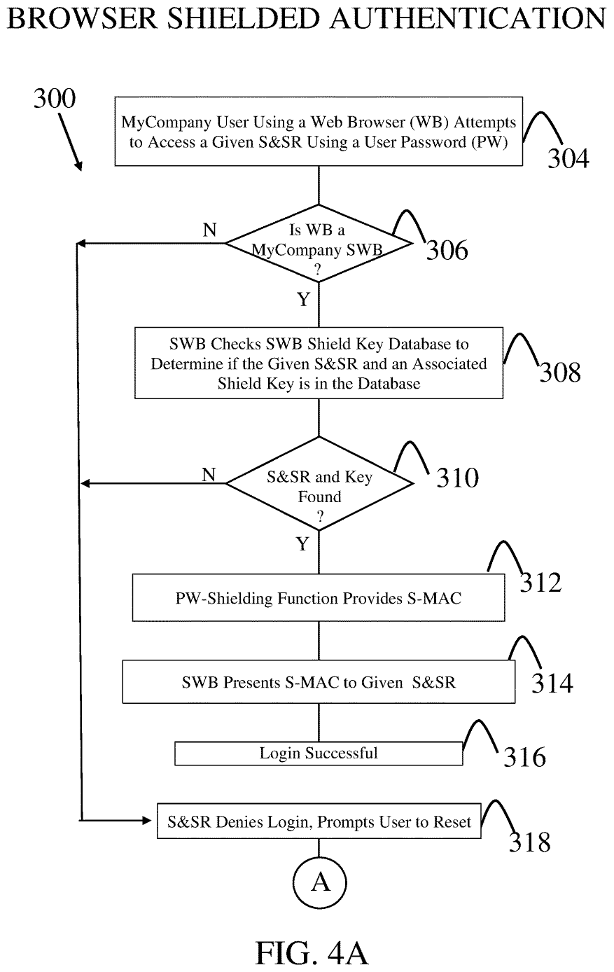

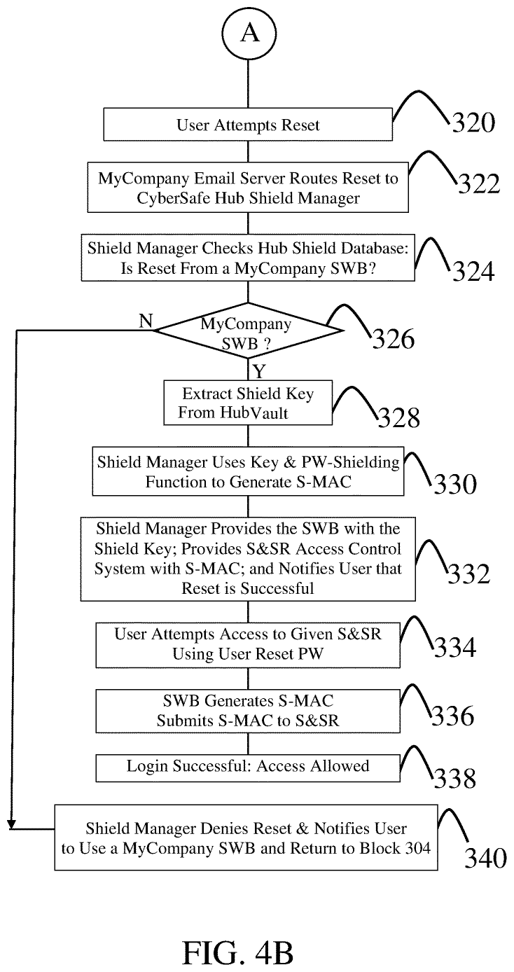

FIGS. 4A and 4B show a flow diagram 300 illustrating operation of Shield engaging with a MyCompany user in a possible scenario by which the MyCompany user attempts to access a MyCompany S&SR in accordance with an embodiment of the disclosure.

In a block 304 a MyCompany user using a web browser (WB) attempts to access a given S&SR using a user password (PW). In a branching block 306 if the WB is a MyCompany Secure Web Browser (SWB) the scenario optionally progresses to a block 308 in which the SWB determines if an identity for the S&SR and an associated Shield Key are present in an SWB Secure Vault (FIG. 3 block 208). In a decision block 310 if the S&SR and Shield Key are found, optionally in a block 312 the SWB invokes the PW-Shielding Function to generate an S-MAC responsive to the user PW accompanying the access request and in a block 314 presents the S-MAC to the S&SR. In a block 316, the S-MAC is authenticated by a MyCompany S&SR access control system, and the SWB is granted access to the S&SR.

On the other hand, if in decision block 310 the Shield Key and S&SR are not found, the SWB cannot and does not submit the request for access together with an S-MAC, and optionally in a block 318 access to the S&SR is denied and the user is prompted to reset the user PW. Optionally the prompt notification comprises a limited reset link provided via email or SMS from a MyCompany email server and in a block 320 the user attempts to reset by clicking on the link and entering a reset PW. In a block 322 MyCompany email server routes the reset to the CyberSafe hub Shield manager for processing. In a block 324 the Shield Manager checks the hub Shield Database to determine, optionally in accordance with a sign-in procedure similar to sign-in procedure 100, if the reset request is from a MyCompany SWB. In a branching block 326 if the request is not from a MyCompany SWB the scenario proceeds to a block 340. In block 340 Shield Manager denies resetting the PW and notifies the user to use a MyCompany SWB.

However, in the current scenario thread of flow diagram 300, as described above with reference to decision block 306, the request is assumed to be from an SWB and the scenario proceeds to a block 328. In block 328 Shield accepts the reset PW as a Shield PW, extracts a Shield Key from the hub Secure Vault and in a block 330 uses a PW-Shielding Function to generate an S-MAC responsive to the reset PW. Optionally in a block 332 Shield Manager provides the SWB with the Shield Key, which the SWB sequesters in the SWB Secure Vault, makes the S-MAC available to the MyCompany CyberSafe Shield access control system and notifies the user that the reset is successful. Subsequently, in a block 334 the user attempts access to the S&SR via the SWB using the reset user PW. In a block 336, responsive to the reset PW the SWB invokes the PW-Shielding Function to produce an S-MAC using the Shield Key received from Shield Manager and submits the reset PW and SMAC with a request for access to the given S&SR. Responsive to the submission of the S-MAC and reset PW, the SWB is granted access to the given S&SR.

If on the other hand in branching block 306, the user is using a WB that is not a MyCompany SWB, the WB the user is using cannot generate and provide an S-MAC with the access request, because the WB does not have and cannot acquire a Shield Key required by CyberSafe Shield to generate an appropriate S-MAC. As a result, the scenario optionally proceeds from block 306 to block 318 where the user's WB is denied access to the given S&SR and the user is prompted to reset a PW. The scenario may then proceed to block 320 where the user submits a reset request and the user's WB progresses through to block 326 where the user's browser is again denied access and shunted from block 326 to block 340 where the user is advised to use a MyCompany SWB.

Whereas in the above discussion each MyCompany user and particular MyCompany SWB that the user uses are, as described above issued an exclusive Shield Key in response to a request to access an S&SR, in some circumstances it may be advantageous to provide a group of users and SWBs that they use with a common shared Shield Key so that each user in the group is enabled to access an S&SR with a shared S-MAC. The shared S-MAC comprises an encryption that is common to all S-MACs generated by SWBs having the same shared Shield Key.

In an embodiment to provide the users with a shared Shield Key, when a user of the group of users using a MyCompany SWB requests to reset her or his PW, for example as described in flow diagram 300, the user's SWB is issued in response to the request and acceptance of the user's reset PW not only a Shield Key but a common “Ghost password (PW)”. The Ghost PW, as the Shield Key, is stored in the SWB secure vault and is not disclosed or accessible to the user. The Ghost PW is associated with the reset user PW and user SWB, and the SWB is configured to generate an S-MAC that comprises an encryption of the Ghost PW. The same Ghost PW is common to all the users of the group, the SWBs via which the users request to reset their respective PWs, and the different reset PWs they respectively request to have accepted by Shield. Optionally the S-MAC also comprises, or is otherwise associated with, the Ghost PW and/or user reset PW associated with the Ghost PW, whenever the S-MAC is presented to an S&SR for permission to access the S&SR.

In an embodiment a shared Shield Key may be shared by a plurality of different MyCompany SWBs that are used by a same, optionally one, MyCompany user.

In an embodiment of the disclosure an S-MAC may be tagged to invoke a particular CyberSafe, MyCompany, and/or Shield action or procedure when presented for a user access to an S&SR. For example, the S-MAC may be tagged to invoke a particular security policy or monitoring format, such as by way of example a high-resolution, continuous monitoring format of user activity when interacting with the S&SR, or allowing access to the S&SR for a particular period of time, or time of day (TOD).

There is therefore provided in accordance with an embodiment of the disclosure a method of constraining a user having a user password (PW) for accessing a given digital resource to use a web browser (WB) from a set of one or more selected WBs to access the digital resource, the method comprising: providing the WB with an encryption key associated with the user PW and unknown and inaccessible to the user; configuring the WB to use the encryption key to generate a Shielded Message Authentication Code (S-MAC) and present the the S-MAC whenever requesting access to the given digital resource; and configuring an access control system that gatekeeps access to the given digital resource to refuse a request for access that does not include the S-MAC. Optionally the method comprises configuring the access control system to refuse access if the access request does not include the user PW. Additionally, or alternatively the S-MAC may comprise an encryption of the user PW encrypted using the encryption key. Optionally, the encryption of the user PW comprises an encryption of a hash of the user PW. Additionally, or alternatively the S-MAC may comprise a concatenation of the user PW and the encrypted user PW.

In an embodiment the encryption key is exclusive to the user. In an embodiment the encryption key is exclusive to the WB. In an embodiment the encryption key is exclusive to the user equipment (UE) hosting the WB.

In an embodiment the method comprises providing the WB with a ghost password associated with the user password. Optionally the ghost password is unknown and inaccessible to the user. Additionally, or alternatively, the S-MAC may comprise an encryption of the ghost password. In an embodiment the ghost password and encryption key are shared with a plurality of users. In an embodiment the ghost password and encryption key are shared with a plurality of WBs.

In an embodiment the method comprises tagging the S-MAC to invoke a particular action or procedure responsive to presentation of the S-MAC.

In an embodiment the method comprises, notifying the user to reset the user password and that access is refused if the user requests access to the resource from a WB that does not present an S-MAC. Optionally the method comprises denying reset of the user password if the user attempts to reset from a WB that is not a member of the set of one or more selected WBs. Optionally the method comprises accepting the reset and providing the the encryption key in association with the reset PW if the user attempts to reset from a WB belonging to the set of one or more selected WBs.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method for comprising:
detecting a first request for access to a first resource using a first password, wherein the first password corresponds to a user of a web browser;
retrieving, by the web browser, a first encryption key associated with the first resource;
generating a first Message Authentication Code (MAC) based on the first password and the first encryption key associated with the first resource;
submitting the first request for access to the first resource with the first MAC; and
based on authentication of the first MAC by an access control system, granting access to the first digital resource via the web browser.

2. (canceled)

3. The method of claim 1, wherein generating the first MAC comprises encrypting of the first password with the first encryption key.

4. The method of claim 3, further comprising hashing the first password to generate a hashed password, wherein encrypting of the first password comprises encrypting the hashed password.

5. The method of claim 3, wherein generating the first MAC comprises concatenating the first password and an encrypted password resulting from encrypting the first password.

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. The method of claim 1, further comprising, based on determining that the first encryption key associated with the first resource cannot be retrieved, denying access to the first resource.

19. The method of claim 18, further comprising:
prompting the user to reset the first password based on denying access to the first resource; and
based on resetting of the first password to a second password, retrieving a second encryption key.

20. The method of claim 19, further comprising:
detecting a second request to access the first resource via the web browser, wherein the second request comprises the second password;
generating, by the web browser, a second MAC based on the second password and the second encryption key;
submitting the second request to access the first resource with the second MAC; and
granting access to the first resource via the web browser.

21. The method of claim 19, further comprising:
based on resetting of the first password to the second password, issuing a third password to the user, wherein the third password is not disclosed or accessible to the user; and
generating a second MAC based on the third password and the second encryption key.

22. The method of claim 1, further comprising, based on detecting a request for access to the first resource that does not include a MAC, denying access to the first resource.

23. The method of claim 1, wherein retrieving the first encryption key associated with the first resource comprises the web browser retrieving the first encryption key from a secure vault.

24. A non-transitory machine-readable medium having program code stored thereon, the program code comprising instructions to:
detect a first request for access to a first resource using a first password, wherein the first password corresponds to a user of a web browser;
determine, by the web browser, whether a first encryption key associated with the first resource can be retrieved;
based on retrieval of the first encryption key, generate a first message authentication code (MAC) based on the first password and the first encryption key associated with the first resource;
submit the first request for access to the first resource with the first MAC; and
determine whether to grant the web browser access to the first resource, wherein the instructions to determine whether to grant the web browser access to the first resource comprise instructions to, based on authentication of the first MAC by an access control system, grant access to the first resource via the web browser.

25. The non-transitory machine-readable medium of claim 24, wherein the instructions to generate the first MAC based on the first password and the first encryption key comprise instructions to encrypt the first password with the first encryption key.

26. The non-transitory machine-readable medium of claim 25, wherein the program code further comprises instructions to hash the first password to generate a hashed password, wherein the instructions to encrypt the first password comprise instructions to encrypt the hashed password.

27. The non-transitory machine-readable medium of claim 24, wherein the program code further comprises instructions to, based on a determination that the first encryption key cannot be retrieved, deny access to the first resource.

28. The non-transitory machine-readable medium of claim 24, wherein the program code further comprises instructions to, based on a determination that the first encryption key associated with the first resource cannot be retrieved, deny access to the first resource.

29. The non-transitory machine-readable medium of claim 28, wherein the program code further comprises instructions to:
prompt the user to reset the first password based on denial of access to the first resource; and
based on resetting of the first password to a second password, retrieve a second encryption key.

30. The non-transitory machine-readable medium of claim 29, wherein the program code further comprises instructions to:
detect a second request for access to the first resource via the web browser, wherein the second request comprises the second password;
generate, by the web browser, a second MAC based on the second password and the second encryption key;
submit the second request to access the first resource with the second MAC; and
grant access to the first resource via the web browser.

31. A system comprising:
a first user equipment having an instance of a secure web browser installed thereon,
wherein the secure web browser is programmed to,
detect an attempt by a user to access to a first resource using a first password;
determine if a first encryption key associated with the first resource can be retrieved;
based on retrieval of the first encryption key, generate a first message authentication code (MAC) based on the first password and the first encryption key associated with the first resource; and
submit a first request for access to the first resource with the first MAC; and
a data processing hub accessible via an IP (internet protocol) address, wherein the data processing hub is programmed to,
based on authentication of the first MAC, grant access to the first resource via the secure web browser.

32. The system of claim 31, wherein generation of the first MAC based on the first password and the first encryption key comprises encryption of the first password with the first encryption key to generate the first MAC.

33. The system of claim 31, wherein the secure web browser is further programmed to, based on a determination that the first encryption key cannot be retrieved, deny access to the first resource.
